(19) United States
(12) Patent Application Publication
(10) Pub. No.: US 2006/0114119 A1
(43) Pub. Date: Jun. 1, 2006

(54) Remote control device and display device

(75) Inventors: Kazuhiko Matsumura, Nara (JP); Kohji Yoshifusa, Hiroshima (JP); Kohji Hisakawa, Nara (JP); Hajime Kashida, Nara (JP); Fumihiko Aoki, Nara (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka (JP)

(21) Appl. No.: 11/288,419

(22) Filed: Nov. 29, 2005

(30) Foreign Application Priority Data
Nov. 30, 2004 (JP) 2004-346758

(51) Int. Cl. G06F 13/42

(52) U.S. Cl. 340/825

(57) ABSTRACT

In an embodiment of the present invention, a remote control device is provided with an optical indicator device and a light-receiving device, and a display device accommodates the light-receiving device of the remote control device, wherein the optical indicator device emits as output a position detection light signal and a function control light signal, these being transmitted to the light-receiving device. The light-receiving device is provided with a position detection light-receiving element, which is for receiving as input the position detection light signal, and a function control light-receiving element, which is for receiving as input the function control light signal. When the optical indicator device moves, the position detection light signal (light-reception signal), which is received as input by the position detection light-receiving element, tracks the movement thereof and changes accordingly. A display position of a pointer is caused to move in response to a position signal obtained by calculating change in the light-reception signal.

### CROSS-REFERENCE TO RELATED APPLICATIONS

This application claims priority under 35 U.S.C. §119(a) on Patent Application No. 2004-346758 filed in Japan on Nov. 30, 2004, the entire contents of which are hereby incorporated by reference.

### BACKGROUND OF THE INVENTION

1. Field of the Invention

The present invention relates to remote control devices that optically control a position of a mark such as a pointer (cursor), which is displayed on a display screen of a display device, at a position apart from the display device and to display devices that incorporate such a remote control device.

2. Description of the Related Art

Conventionally, remote control devices that perform control mechanically are known as devices for achieving operation of a cursor displayed on a display screen of a display device from a distant position. In remote control devices that perform control mechanically, a cross-shaped cursor key or a ball pointing device for example acts as a means for inputting position signals. In addition to these, coordinate input devices equipped with electrostatic pads or a joystick are also known.

In addition to the above-mentioned remote control devices that use mechanical control, remote control devices provided with a remote operation body, which has a light-emitting element, and a controller portion that receives light from the remote operation body to detect indicated locations, have been proposed (see Japanese patent No. 3273531 for example) as optical remote coordinate indicating devices that use light-emitting elements.

The remote operation body of this remote coordinate indicating device is provided with a central light-emitting element arranged centrally and an upward direction light-emitting element system, a downward direction light-emitting element system, a rightward light-emitting element system, and a leftward light-emitting element system arranged inclined such that their light axes are in a direction separated from the center of the central light-emitting element, and since a total of five light-emitting element systems are provided, it is a structurally complicated configuration, with the control system thereof similarly complicated. Furthermore, power consumption increases since a plurality of light-emitting elements are required, such that it has the problem of being impractical as a remote control device.

With conventional remote control devices, when moving the cursor to a desired position using the attached cross-shaped cursor key or the like, only stepped movements are possible and their direction also is only vertical and lateral, such that they are insufficient for smooth diagonal movement.

Furthermore, with ball pointers, electrostatic pads, and joysticks, simple one-handed operation is not intuitive and it has not been possible to execute cursor movement in an intended manner.

Furthermore, with the proposed optical remote coordinate indicating device, many light-emitting elements are required, such that there has been a problem of being impractical as a remote control device.

### SUMMARY OF THE INVENTION

The present invention has been devised in consideration of these circumstances, and it is an object therein to provide a remote control device that is capable of smoothly, speedily, and precisely controlling a position of a mark such as a pointer (cursor) displayed on a display screen of a display device and that is a low-power consumption type having a small number of light-emitting elements, by being provided with an optical indicator device having two light-emitting elements, and a light-receiving device that receives as input the position detection light signal from the optical indicator device to detect a light-reception signal and obtains a position signal from the light-reception signal.

Furthermore, another object is to provide a display device in which a pointer on a display screen can be controlled freely with excellent operability by being provided with the aforementioned remote control device.

A remote control device according to the present invention is provided with an optical indicator device in which a first light-emitting element and a second light-emitting element are mounted that emit as output a position detection light signal, and a light-receiving device that receives as input the position detection light signal and obtains a position signal from a detected light-reception signal, wherein a light axis of the first light-emitting element has an inclination angle not greater than a half value angle of the first light-emitting element to a reference axis in a first direction that intersects the reference axis of the optical indicator device, and a light axis of the second light-emitting element has an inclination angle not greater than a half value angle of the second light-emitting element to the reference axis in a second direction that intersects the first direction.

With this configuration, the inclination angles of the first light-emitting element and the second light-emitting element are not greater than a half value angle of the light-emitting elements to a reference axis of the optical indicator device, and therefore the position detection light signals can be detected with excellent accuracy using the directivity in the light intensity distribution characteristics possessed by the light-emitting elements. That is, the light-receiving device can detect (the light intensity of) the position detection light signals of both the first light-emitting element and the second light-emitting element by their condition of relative strength (magnitude of light-reception signals), and therefore the position signal can be obtained by comparing the magnitude of the light-reception signals corresponding to both the position detection light signals and performing arithmetic processing. Using this position signal, it becomes possible to control a mark such as a pointer (cursor) displayed on a display screen for example. Furthermore, a remote control device that consumes little power is achieved by configuring the optical indicator device using two light-emitting elements.

In a remote control device according to the present invention, it is possible that the first light-emitting element is mounted at a first surface formed in the first direction, and the second light-emitting element is mounted at a second surface formed in the second direction.

With this configuration, the light-emitting elements are mounted on surfaces, and therefore stable mounting can be achieved and a stable inclination angle can be maintained.

In a remote control device according to the present invention, it is possible that the first surface and the second surface are configured as two adjacent side surfaces of a multi-sided pyramid or a multi-sided prismoid.

With this configuration, the light-emitting elements are mounted on two adjacent side surfaces in a multi-sided pyramid or a multi-sided prismoid, and therefore it is possible to reliably carry out emission as output of position detection light signals toward the light-receiving device.

In a remote control device according to the present invention, it is possible that an angle of intersection of the first direction and the second direction is 90 degrees.

With this configuration, the relative difference between the position detection light signals from the first light-emitting element and the second light-emitting element can be made larger, thus enabling the detection accuracy of the position signals to be improved.

In a remote control device according to the present invention, it is possible that the first light-emitting element and the second light-emitting element have different light emission wavelengths.

With this configuration, the first light-emitting element and the second light-emitting element are set to different light emission wavelengths, and therefore detection by the light-receiving device is facilitated and detection accuracy can be improved.

In a remote control device according to the present invention, it is possible that the first light-emitting element has a light emission wavelength in an infrared light region or a visible light region, and the second light-emitting element has a light emission wavelength in a visible light region or an infrared light region.

With this configuration, the light emission wavelengths are divided into the infrared light region and the visible light region, and therefore light-emitting elements of different light emission wavelengths can be configured easily.

In a remote control device according to the present invention, it is possible that light intensity distribution patterns at a surface vertical to the light axes of the first light-emitting element and the second light-emitting element are oval shaped. Furthermore, in a remote control device according to the present invention, it is possible that major axis directions of the oval shapes of the light intensity distribution patterns of the first light-emitting element and the second light-emitting element are intersecting. Furthermore, in a remote control device according to the present invention, it is possible that an angle of intersection of the major axis directions is 90 degrees.

With this configuration, the light intensity distribution patterns are set to oval shapes and arranged intersecting in a major axis direction, and therefore the relative difference between the position detection light signals, which are received as input by the light-receiving device, from the first light-emitting element and the second light-emitting element can be made larger, thus enabling the detection accuracy of the light-receiving device to be improved. In particular, the difference between the position detection light signals can be reliably made larger by setting the angle of intersection to 90 degrees.

In a remote control device according to the present invention, it is possible that the position detection light signals are emitted as output by applying light emission pulse signals in which a modulation carrier wave is superimposed on the position detection pulses respectively to the first light-emitting element and the second light-emitting element.

With this configuration, the position detection light signals are produced in a pulse form by light emission pulse signals having position detection pulses and, moreover, the position detection light signals can be reliably separated from disturbance light (noise) by superimposing the modulation carrier wave, and therefore the controllability of the remote control device can be improved. Furthermore, detection is achieved as a pulse-shaped light-reception signal, and therefore arithmetic processing on the light-reception signal can be carried out with excellent precision and ease using a CPU (central processing unit) for example.

In a remote control device according to the present invention, it is possible that the light emission pulse signal has a detection start pulse, on which the modulation carrier wave is superimposed, before the position detection pulses.

With this configuration, the light emission pulse signals are divided into a detection start pulse and position detection pulses, with the detection start pulse being produced first, and therefore necessary adjustments at the light-receiving device can be carried out, thus enabling detection accuracy of the light-reception signals to be improved.

In a remote control device according to the present invention, it is possible that the position detection pulses are constituted by a plurality of pulses having a same pulse width and a same cycle.

With this configuration, a plurality of same pulses are repetitively produced, and therefore the accuracy of signal processing can be improved, and the accuracy of position detection can be improved.

In a remote control device according to the present invention, it is possible that the light-receiving device comprises two position detection light-receiving elements having different wavelength selection characteristics corresponding to the light emission wavelengths.

With this configuration, the light-receiving device can receive light as input in response to light emission wavelengths from the optical indicator device, and therefore detection of light-reception signals is facilitated and detection accuracy can be improved.

In a remote control device according to the present invention, it is possible that the position detection light-receiving elements comprise optical filters having different wavelength selection characteristics.

With this configuration, optical filters having wavelength selection characteristics are used, and therefore the characteristic specifications of the position detection light-receiving elements can be simplified.

In a remote control device according to the present invention, it is possible that the position signal is obtained by performing arithmetic processing on a difference between output levels of light-reception signals detected by the two position detection light-receiving elements. In a remote control device according to the present invention, it is possible that the position signal is obtained by performing arithmetic processing on a ratio of output levels of light-reception signals detected by the two position detection light-receiving elements. Furthermore, in a remote control device according to the present invention, it is possible that the position signal is obtained by performing arithmetic processing on a difference between and a ratio of output levels of light-reception signals detected by the two position detection light-receiving elements.

With this configuration, arithmetic processing is carried out using the difference between output levels of the light-reception signals, the ratio of the output levels of the light-reception signals, or the difference between and the ratio of the output levels of the light-reception signals, and therefore simple arithmetic processing can be achieved. Furthermore, when using both the difference and the ratio, the detection accuracy can be further improved.

In a remote control device according to the present invention, it is possible that the light-receiving device comprises a first light-receiving circuit and a second light-receiving circuit corresponding respectively to the two position detection light-receiving elements and an arithmetic processing portion that obtains a position signal by performing arithmetic processing on the light-reception signals detected by the first light-receiving circuit and the second light-receiving circuit.

With this configuration, the first light-receiving circuit and the second light-receiving circuit are provided corresponding to the two position detection light-receiving elements and arithmetic processing is carried out on the respective detected light-reception signals, and therefore the light-reception signals can be processed easily and precisely.

In a remote control device according to the present invention, it is possible that the first light-receiving circuit and the second light-receiving circuit respectively comprise the position detection light-receiving element that receives as input the position detection light signal to detect a light-reception signal, an amplifier circuit that amplifies the light-reception signal detected by the position detection light-receiving element, and an amplitude value detection circuit that detects an amplitude value of the light-reception signal amplified by the amplifier circuit.

With this configuration, the amplitude values of the light-reception signals can be regulated to appropriate values by the amplifier circuits and the amplitude values of the light-reception signals can be detected, and therefore the output levels (relative light intensities) of the light-reception signals can be detected with excellent accuracy and ease.

In a remote control device according to the present invention, it is possible that amplitude values obtained for a plurality of pulses of the light-reception signals corresponding to the position detection pulses are averaged and the average is set as an amplitude value of the light-reception signals.

With this configuration, the amplitude values of a plurality of pulses of the light-reception signals, which have a plurality of pulses, are detected and averaged, so that error due to shaking of the position detection light signals due to shaking of the optical indicator device can be removed, and the detection accuracy of light-reception signals can be improved.

In a remote control device according to the present invention, it is possible that a band-pass filter is connected between the amplifier circuit and the amplitude value detection circuit.

With this configuration, amplitude values are obtained for light-reception signals from which signals (noise) other than the predetermined frequency have been eliminated using a band-pass filter, and therefore the detection accuracy of light-reception signals can be improved.

In a remote control device according to the present invention, it is possible that amplification factor of the amplifier circuit is regulated by an automatic gain control circuit.

With this configuration, the amplification factor of the amplifier circuit can be automatically regulated using an automatic gain control circuit, and therefore the output levels of the light-reception signals can be regulated to appropriate values and arithmetic processing can be carried out easily and precisely.

In a remote control device according to the present invention, it is possible that the amplification factor is regulated such that the amplitude value of the light-reception signal corresponding to the detection start pulse does not saturate.

With this configuration, the amplitude values of the light-reception signals do not saturate, and therefore precise light-reception signals (output levels, amplitude values) can be obtained with high reliability.

A display device according to the present invention may be a display device provided with a display portion that displays information and a frame portion that supports the display portion, and may comprise a remote control device according to the present invention, wherein the light-receiving device is arranged at a front surface of the frame portion.

With this configuration, the light-receiving device can be confirmed visually, and therefore the direction of the reference axis of the optical indicator device can be accurately turned toward the direction of the light-receiving device, thereby enabling the position detection light signals to be reliably received as input.

In a display device according to the present invention, it is possible that the optical indicator device emits as output and transmits to the light-receiving device a function control light signal corresponding to a function control signal that controls a function of the display device, and the light-receiving device receives as input the function control light signal and outputs the function control signal.

With this configuration, in addition to position detection (position control) of a mark (pointer), it is possible to control functions of the display device, and therefore it is possible to achieve a display device provided with a remote control device with high usefulness.

In a display device according to the present invention, it is possible that the optical indicator device comprises a third light-emitting element that emits as output the function control light signal.

With this configuration, a third light-emitting element is used separately from the first light-emitting element and the second light-emitting element, which emit position detection light signals, to emit as output a function control light signal, and therefore the function control detection light signal can be emitted as output easily and control of the functions of the display device can be carried out easily, speedily, and precisely.

In a display device according to the present invention, it is possible that the third light-emitting element has a light emission wavelength in an infrared light region or a visible light region.

With this configuration, the influence of disturbance light (noise) can be reduced to allow improvement in the detection accuracy of the function control light signals by setting the light emission wavelength of the third light-emitting element to a predetermined wavelength.

In a display device according to the present invention, it is possible that the function control light signal is emitted as output from either the first light-emitting element or the second light-emitting element.

With this configuration, a light-emitting element (the first light-emitting element or the second light-emitting element), which emit the position detection light signals, can be combined in use for a light-emitting element (the third light-emitting element) that emits function control light signals, and therefore the number of light-emitting elements required in the optical indicator device can be reduced to enable the configuration to be simplified.

In a display device according to the present invention, it is possible that the light-receiving device comprises a function control light-receiving element that receives as input the function control light signal.

With this configuration, a function control light signal is received as input using a function control light-receiving element separate from the position detection light-receiving elements, and therefore the function control light signal can be received as input easily and control of the functions of the display device can be carried out easily, speedily, and precisely.

In a display device according to the present invention, it is possible that the function control light-receiving element has a wavelength selection characteristic corresponding to the light emission wavelength.

With this configuration, since the function control light-receiving element has a wavelength selection characteristic, the display device is provided with a light-receiving device (remote control device) capable of receiving as input a function control light signal with little influence of disturbance light (noise).

In a display device according to the present invention, it is possible that the function control light signal is received as input by either of the two position detection light-receiving elements.

With this configuration, the function control light signal is received as input by the position detection light-receiving element, and therefore the number of light-receiving elements required in the light-receiving device can be reduced to enable the configuration to be simplified.

In a display device according to the present invention, it is possible that a position of a mark displayed on the display portion is controlled according to the position signal.

With this configuration, the movement of the mark, such as a pointer, displayed on the display portion of a display device can be controlled easily.

In a display device according to the present invention, it is possible that the display device is a television receiver.

With this configuration, a television receiver can be achieved provided with a new function (an optical pointer function).

As described above, with the remote control device according to the present invention, which is a remote control device provided with an optical indicator device that emits as output a position detection light signal using two light-emitting elements, and a light-receiving device that receives as input the position detection light signal and detects the light-reception signal to obtain a position signal from the light-reception signal, since the inclination angles of the two light-emitting elements are not greater than half value angles to the reference axis of the optical indicator device, an effect is achieved by which the number of light-emitting elements is reduced to simplify the optical indicator device and a low power consumption type remote control device can be achieved at low cost and with excellent operability.

Furthermore, with the remote control device according to the present invention, since a light-receiving device is provided by which the position detection light signals respectively emitted as output by the two light-emitting elements are detected as light-reception signals by two position detection light-receiving elements (light-receiving circuits), with arithmetic processing being performed on the output levels (amplitude values) of the light-reception signals to obtain position signals from the optical indicator device, an effect is achieved by which a position of a mark such as a pointer (cursor) displayed on a display screen of a display device for example can be controlled smoothly, speedily, and precisely.

Moreover, with the display device according to the present invention, since a display device is provided that accommodates a light-receiving device incorporating a remote control device according to the present invention, an effect is achieved by which a display device can be provided that is capable of freely controlling the position of a mark (cursor, pointer) displayed on a display screen.

### BRIEF DESCRIPTION OF THE DRAWINGS

FIG. 1 is an explanatory diagram that shows an outline of principal components of a remote control device according to the present invention and a display device according to the present invention provided with such a remote control device.

FIG. 2 is a principle explanatory diagram for describing the operational principles of the present invention and is a schematic diagram that schematically illustrates the optical indicator device and the light-receiving device (position detection light-receiving element) of the remote control device.

FIG. 3 is a principle explanatory diagram for describing the operational principles of the present invention and is a graph showing correlation between the relative light intensity of the position detection light signal (light-reception signal) detected by the position detection light-receiving element and the reference axis displacement angle as a relative light intensity to reference axis displacement angle characteristic.

FIG. 4 is an explanatory diagram for describing one working example of an optical indicator device in a remote control device according to the present invention and is a front view of an optical indicator device as seen from a direction facing the light-receiving device.

FIGS. 5A and 5B are explanatory diagrams for describing one working example of an optical indicator device in a remote control device according to the present invention, wherein FIG. 5A is a bottom view of the optical indicator device of FIG. 4 as seen from a bottom side, and FIG. 5B shows light intensity distribution patterns on the 5B to 5B arrows shown in FIG. 5A.

FIGS. 6A and 6B are explanatory diagrams for describing one working example of an optical indicator device in a remote control device according to the present invention, wherein FIG. 6A is a lateral view of the optical indicator device of FIG. 4 as seen from the left side, and FIG. 6B shows light intensity distribution patterns from the arrows 6B to 6B shown in FIG. 6A.

FIGS. 7A and 7B are graphs showing correlation between the relative light intensity of the light-reception signal detected by the position detection light-receiving element receiving the position detection light signal from the optical indicator device shown in FIGS. 4 through 6B, and the reference axis displacement angle as relative light intensity to reference axis displacement angle characteristics.

FIGS. 8A and 8B are front views of modified examples of optical indicator devices in remote control devices according to the present invention as shown in FIG. 4.

FIG. 9 is a waveform chart showing an example waveform of light emission pulse signals at the optical indicator device of a remote control device according to the present invention.

FIG. 10 is a block diagram showing a working example of a circuit block of the light-receiving device in a remote control device according to the present invention.

FIGS. 11A and 11B are waveform diagrams showing examples of amplitude values of light-reception signals that have been output from band-pass filters.

### DESCRIPTION OF THE PREFERRED EMBODIMENTS

Hereinafter, embodiments of the present invention will be described with reference to the accompanying drawings.

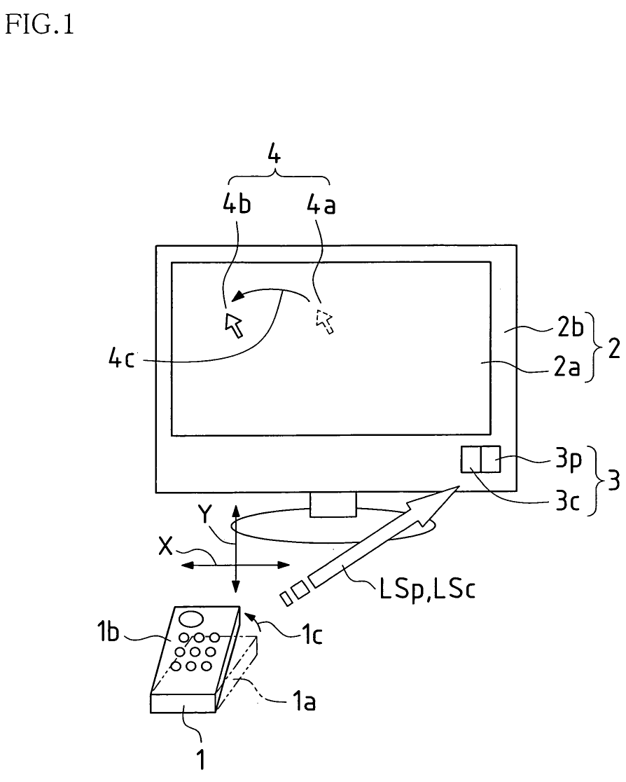

FIG. 1 is an explanatory diagram showing an outline of principal portions of a remote control device according to the present invention and a display device according to the present invention provided with such a remote control device.

A remote control device according to the present invention is a so-called remote controller and is constituted by an optical indicator device 1 and a light-receiving device 3. Furthermore, a display device 2 according to the present invention contains the light-receiving device 3 of the remote control device according to the present invention. The display device 2, which is a monitor or a television receiver or the like that displays information such as images and data, has a display portion 2a at a central area of a front surface and a frame portion 2b that supports the display portion 2a is provided at the perimeter thereof. The light-receiving device 3 is arranged (contained) at a front surface of the frame portion 2b. It should be noted that the light-receiving device 3 may also be provided in the display portion 2a.

A pointer 4 is displayed on the display screen of the display portion 2a as a mark (cursor). A before-movement pointer 4a, an after-movement pointer 4b, and a movement trajectory 4c of the pointer 4 are shown schematically in this drawing.

The optical indicator device 1 emits as output a position detection light signal LSp and a function control light signal LSc, which are transmitted to the light-receiving device 3. The position detection light signal LSp and the function control light signal LSc may be in a form in which these signals are transmitted from separate optical indicator devices, but configuring these signals such that they are emitted as output from a single optical indicator device 1 is preferable since this allows the structure of the remote control device to be simplified.

The light-receiving device 3 is provided with a position detection light-receiving element 3p, which is for receiving as input (detecting) the position detection light signal LSp, and a function control light-receiving element 3c, which is for receiving as input (detecting) the function control light signal LSc. It should be noted that it is possible to combine the position detection light-receiving element 3p and the function control light-receiving element 3c by devising the control mode and transmission mode.

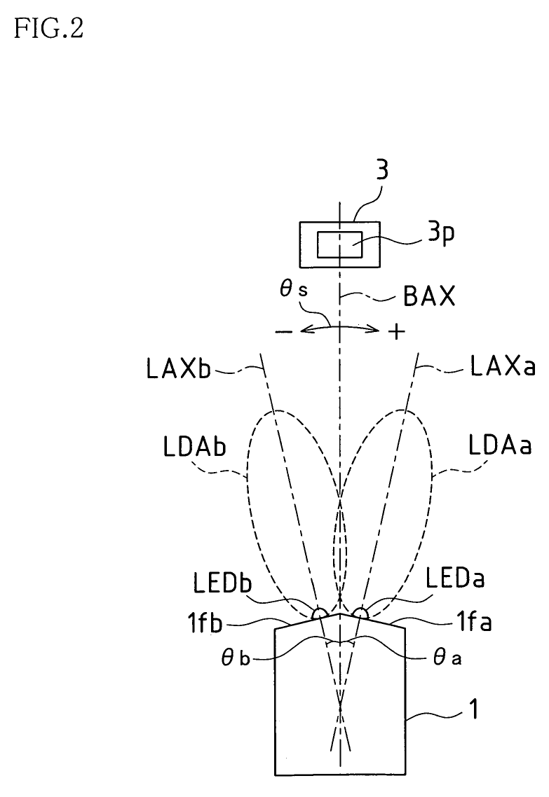

When (a reference axis BAX (see FIG. 2) of) the optical indicator device 1 is moved from an optical indicator device 1a to an optical indicator device 1b as shown by the movement trajectory 1c, the position detection light signal LSp that is received as input by the position detection light-receiving element 3p tracks the movement and changes accordingly. By detecting the position detection light signal LSp as a light-reception signal, the light-receiving device 3 is capable of conducting arithmetic processing to detect (output) change in the light-reception signal as a position signal.

Accordingly, the display position of the pointer 4 can be controlled and made to move in response to the detected position signal. It should be noted that an X-axis (horizontal direction movement) as a first direction and a Y-axis (vertical direction movement) as a second direction intersecting the first direction are shown as examples of detection references for when detecting movement of (the reference axis BAX of) the optical indicator device 1. To simplify the arithmetic processing and to improve detection accuracy, it is very preferable that the intersecting angle of the first direction and the second direction are set to 90 degrees as with the X-axis and Y-axis.

The function control light signal LSc is emitted as output (transmitted) in response to a function control signal for controlling the functions of the display device 2. In the case of the display device 2 being a television receiver for example, the function control signal includes signals such as a channel selection signal, a volume adjustment signal, a brightness adjustment signal, and an on/off control signal for turning on and off buttons on the display screen using the pointer 4. The function control light signal LSc received by the function control light-receiving element 3c is detected (outputted) by the light-receiving device 3 as a function control signal and the function of the display device 2 is controlled in response to the detected function control signal.

In the remote control device according to the present invention, by performing arithmetic processing on the light-reception signal that corresponds to the position detection light signal LSp that controls the position of the pointer 4 to detect the movement direction of the reference axis BAX of the optical indicator device 1 in addition to the function control light signal LSc that is ordinarily used, it is possible to achieve synchronization to the movement direction of the reference axis BAX and to move with ease the pointer 4 on the display screen to a desired position and it is possible to achieve high-speed, smooth movement control of the position of the pointer 4 compared to remote control device that perform control mechanically.

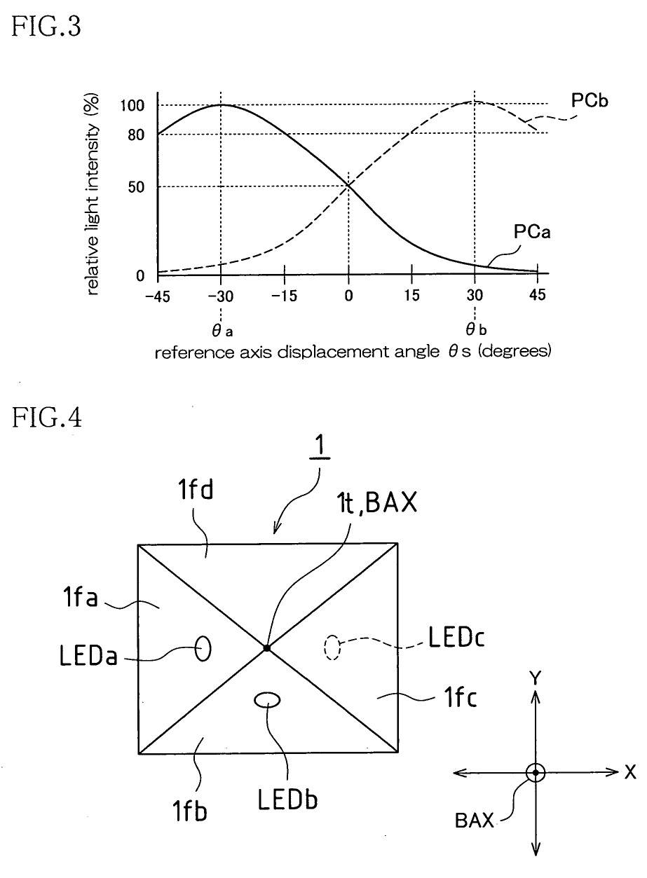

FIGS. 2 and 3 are principle explanatory diagrams for describing the operational principles of the present invention. FIG. 2 is a schematic diagram that schematically illustrates the optical indicator device and the light-receiving device (position detection light-receiving element) of the remote control device, and FIG. 3 is a graph showing correlation between the relative light intensity of the position detection light signal (light-reception signal) detected by the position detection light-receiving element and the reference axis displacement angle as a relative light intensity to reference axis displacement angle characteristic. In FIG. 3, the horizontal axis is the reference axis displacement angle θ (degrees) and the vertical axis is relative light intensity (%). Identical symbols are attached to portions identical to FIG. 1 and description thereof is omitted as appropriate.

A first light-emitting element LEDa and a second light-emitting element LEDb that emit as output the position detection light signal LSp are mounted on surfaces opposing the light-receiving device 3 of the optical indicator device 1.

The first light-emitting element LEDa is arranged on a first surface 1fa that is formed corresponding to the first direction (rightward in drawing) intersecting with the reference axis BAX of the optical indicator device 1. A light axis LAXa of the first light-emitting element LEDa is mounted so as to have an inclination angle θa not greater than a half value angle of the first light-emitting element LEDa to the reference axis BAX in the first direction. It should be noted that a half value angle indicates the directivity of the light-emitting intensity of the light-emitting element and is an angle at which the light intensity becomes half the maximum value in the light intensity distribution characteristics. The directivity of the first light-emitting element LEDa is indicated by the light intensity distribution characteristic LDAa.

The second light-emitting element LEDb is arranged on a second surface 1fb that is formed corresponding to the second direction (leftward in drawing) intersecting with the reference axis BAX of the optical indicator device 1. A light axis LAXb of the second light-emitting element LEDb is mounted so as to have an inclination angle θb not greater than a half value angle of the second light-emitting element LEDb to the reference axis BAX in the second direction. The directivity of the second light-emitting element LEDb is indicated by the light intensity distribution characteristic LDAb.

By configuring the first direction and the second direction to intersect suitably and using a structure in which the light axis LAXa and the light axis LAXb are shifted, it is possible to separate and detect the position detection light signal LSp from the first light-emitting element LEDa and the position detection light signal LSp from the second light-emitting element LEDb. It should be noted that the half value angle (that is, the inclination angle) of the first light-emitting element LEDa and the second light-emitting element LEDb may be different.

By configuring the first light-emitting element LEDa and the second light-emitting element LEDb with light-emitting elements (for example, semiconductor light-emitting diodes: LED) that have different light emission wavelengths, it is easier to detect the light-reception signal corresponding to the position detection light signal LSp of the light-receiving device 3 (position detection light-receiving element 3p), which further improves detection accuracy and enables the position signals to be obtained with excellent precision. For example, one light-emitting element can be set having a light emission wavelength in the infrared light region and the other light-emitting element can be set having a light emission wavelength in the visible light region.

It should be noted that when the light emission wavelengths of the first light-emitting element LEDa and the second light-emitting element LEDb are set the same, detection can be achieved without loss of precision in detecting the position detection light signal LSp by devising the light-emitting elements to have shifted light emission cycles for example.

If the reference axis displacement angle θs is displaced to the plus direction in the drawing, then the position detection light signal LSp from the second light-emitting element LEDb becomes larger, and if the reference axis displacement angle θs is displaced to the minus direction in the drawing, then the position detection light signal LSp from the first light-emitting element LEDa becomes larger.

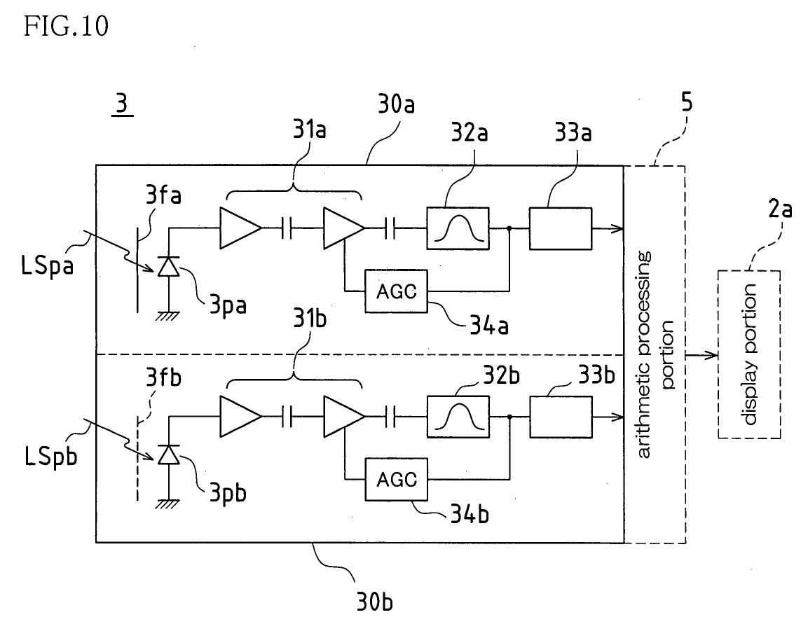

That is to say, by obtaining a relative light intensity PCa from the light-reception signal of a position detection light-receiving element 3pa (see FIG. 10), which receives as input a position detection light signal LSp (LSpa: see FIG. 10) from the first light-emitting element LEDa, obtaining relative light intensity PCb from the light-reception signal of a position detection light-receiving element 3pb (see FIG. 10), which receives as input a position detection light signal LSp (LSpb: see FIG. 10) from the second light-emitting element LEDb, and comparing a magnitude relationship between the relative light intensity PCa and the relative light intensity PCb, it is possible to find the displacement of the reference axis BAX (reference axis displacement angle θs) and therefore remote control can be achieved by outputting that displacement as a position signal (indication signal).

It should be noted that the light-reception signal is obtainable as an electric signal and therefore the relative light intensity PCa and the relative light intensity PCb can be detected in fact as the magnitudes of the electric signals. That is, the position signals are obtained by comparing the sizes of the light-reception signals (output levels).

In FIG. 3, when the reference axis displacement angle θs is “0,” that is, when there is a condition as shown in FIG. 2, the relative light intensity PCa from the first light-emitting element LEDa and the relative light intensity PCb from the second light-emitting element LEDb, which are detected by the position detection light-receiving element 3p, are substantially equivalent. It should be noted that the numerical values in the drawing are shown as examples.

When the reference axis displacement angle θs is set to the plus direction, that is, when the optical indicator device 1 is shifted rightward in FIG. 2, the relative light intensity PCa detected by the position detection light-receiving element 3pa gradually decreases and the relative light intensity PCb detected by the position detection light-receiving element 3pb gradually increases. Moreover, when the reference axis displacement angle θs becomes equivalent to the inclination angle θb of the second light-emitting element LEDb, the second light-emitting element LEDb comes in front of the position detection light-receiving element 3p (3pb), and therefore the relative light intensity PCb becomes the maximum in accordance with the light intensity distribution characteristic LDAb.

When the reference axis displacement angle θs is set to the minus direction, that is, when the optical indicator device 1 is shifted leftward in FIG. 2, the relative light intensity PCa detected by the position detection light-receiving element 3pa gradually increases and the relative light intensity PCb detected by the position detection light-receiving element 3pb gradually decreases. Moreover, when the reference axis displacement angle θs becomes equivalent to the inclination angle θa of the first light-emitting element LEDa, the first light-emitting element LEDa comes in front of the position detection light-receiving element 3p (3pa), and therefore the relative light intensity PCa becomes the maximum in accordance with the light intensity distribution characteristic LDAa.

By performing comparison calculations on the magnitude relationship between the relative light intensities PCa and PCb, the indication direction (movement direction and position signal) of the reference axis BAX can be found, and therefore it is possible to control the movement of the pointer 4 being displayed on the display portion 2a for example using this indication direction (change in the indication direction). It should be noted that the disparity between the relative light intensities PCa and PCb can be such that the disparity is detectable. If the disparity is in a predetermined range, then appropriate correction can be performed by arithmetic processing. That is, it is preferable that the light intensity distribution characteristic LDAa and the light intensity distribution characteristic LDAb are equivalent, but there is no limitation to this. Furthermore, it is preferable that the inclination angle θa and the inclination angle θb are equivalent, but there is no limitation to this.

It should be noted that only one position detection light-receiving element 3p is shown in FIG. 2, but as described above, by providing the position detection light-receiving element 3pa made to correspond to the first light-emitting element LEDa and the position detection light-receiving element 3pb made to correspond to the second light-emitting element LEDb, it becomes easy to separate and detect separately the relative light intensity PCa and the relative light intensity PCb. It should be noted that when it is not necessary to distinguish between the position detection light-receiving element 3pa and the position detection light-receiving element 3pb, description is given referring simply to the position detection light-receiving element 3p.

In the principle explanatory diagrams of FIG. 2 and FIG. 3, examples were shown in which position detection is possible in the leftward and rightward directions for example. By combining detection and control of upward and downward directions in addition to the leftward and rightward directions, it is possible to control the position of the pointer 4 on an X-axis and a Y-axis surface (a two-dimensional display screen).

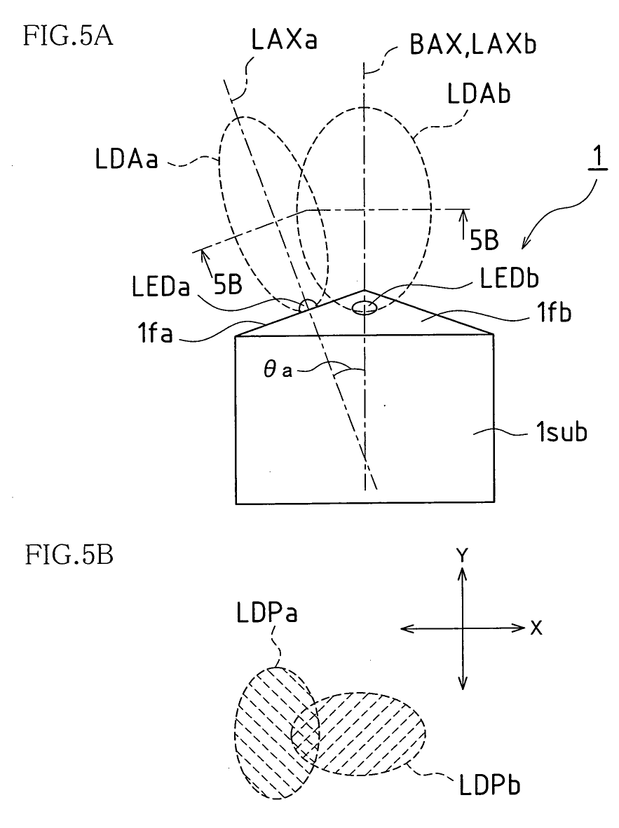

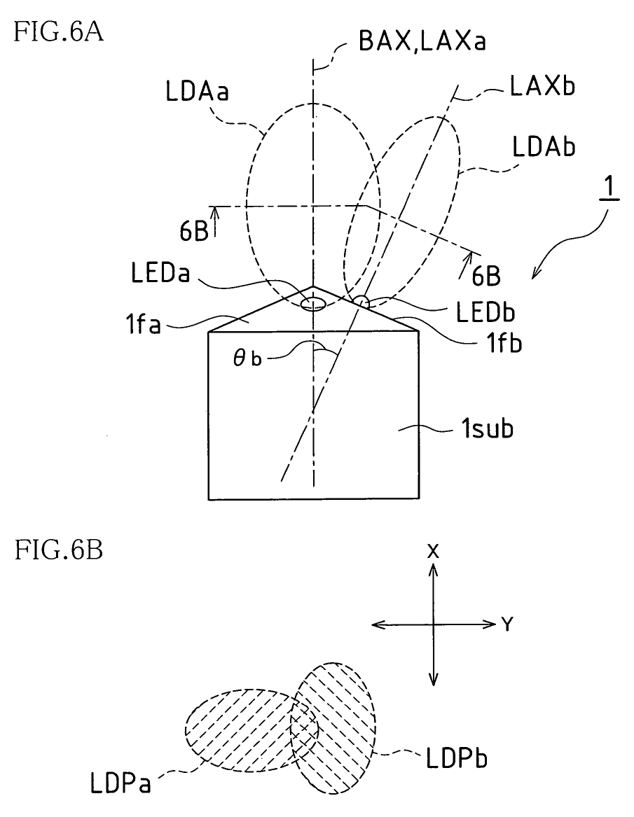

FIGS. 4, 5A, 5B, 6A, and 6B are explanatory diagrams for describing one working example of an optical indicator device in a remote control device according to the present invention. FIG. 4 is a front view of the optical indicator device as seen from a direction facing the light-receiving device. FIG. 5A is a bottom view of the optical indicator device of FIG. 4 as seen from a bottom side, and FIG. 5B shows light intensity distribution patterns from the arrows 5B to 5B shown in FIG. 5A. FIG. 6A is a lateral view of the optical indicator device of FIG. 4 as seen from the left side, and FIG. 6B shows light intensity distribution patterns from the arrows 6B to 6B shown in FIG. 6A. Identical symbols are attached to portions identical to FIGS. 1 through 3 and description thereof is omitted as appropriate.

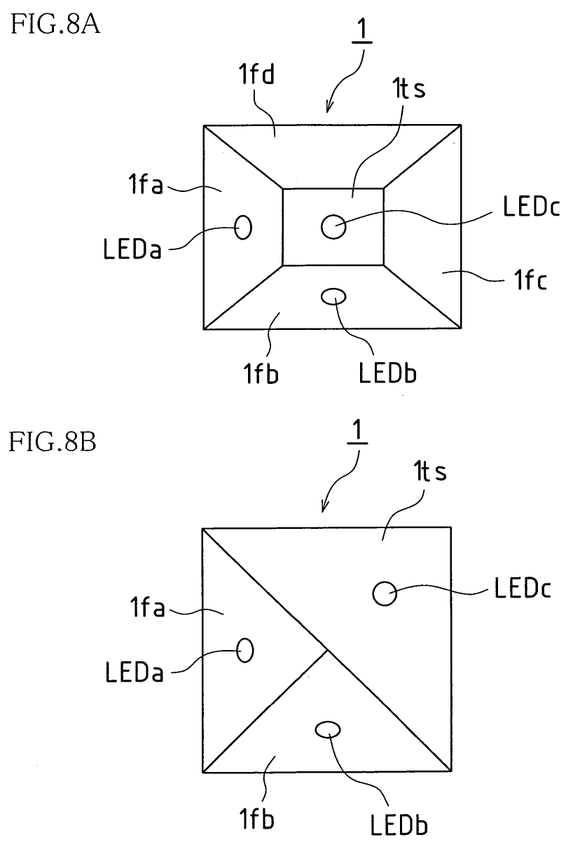

In FIG. 4, the optical indicator device 1 is configured with a four-sided pyramid facing toward the light-receiving device 3, and therefore an apex it and four side surfaces, these being a first surface 1fa, a second surface 1fb, a third surface 1fc, and a fourth surface 1fd, are apparent. Furthermore, an axis orthogonal at the apex 1t from the front side of the paper to the rear side is the reference axis BAX. The first direction, which intersects the reference axis BAX, can be prescribed as the X-axis direction (horizontal direction) for example, and the second direction can be prescribed as the Y-axis direction (vertical direction) for example. It should be noted that, instead of the four-sided pyramid, a four-sided prismoid may be used in which the apex it portion is set as a flat plane in a direction intersecting the reference axis BAX (see FIG. 8A).

The first light-emitting element LEDa is mounted at the first surface 1fa and the second light-emitting element LEDb is mounted at the second surface 1fb. As described above, the first light-emitting element LEDa and the second light-emitting element LEDb emit as output the position detection light signals LSp. Furthermore, it is also possible to mount a third light-emitting element LEDc that emits as output a function control light signal LSc at the third surface 1fc for example. A substrate portion 1sub is connected at the base of the four-sided pyramid, accommodating drive portions for driving the first light-emitting element LEDa, the second light-emitting element LEDb, and the third light-emitting element LEDc and so on, and a switch or the like (not shown) for controlling the drive portions is provided on a surface.

FIG. 5A is a bottom view of the optical indicator device 1, and FIG. 5B shows light intensity distribution patterns from the arrows 5B to 5B (a surface perpendicular to the light axis LAXa and the light axis LAXb) shown in FIG. 5A. At the first direction (X-axis direction) that intersects the reference axis BAX, the light axis LAXa of the first light-emitting element LEDa is configured at an inclination angle θa to the reference axis BAX. By ensuring that the inclination angle θa is not greater than a half value angle of the first light-emitting element LEDa, the position detection light signal LSp from the first light-emitting element LEDa can be detected reliably by the position detection light-receiving element 3p.

The light intensity distribution pattern LDPa of the light intensity distribution characteristic LDAa is set to an oval shape having a minor axis in the X-axis direction and a major axis in the Y-axis direction, while the light intensity distribution pattern LDPb of the light intensity distribution characteristic LDAb is set to an oval shape having a major axis in the X-axis direction and a minor axis in the Y-axis direction. The first light-emitting element LEDa and the second light-emitting element LEDb are configured so as to have the oval shaped light intensity distribution patterns LDPa and LDPb. For example, this can be achieved by setting the chip form of the first light-emitting element LEDa and the second light-emitting element LEDb to a rectangular form, and devising a lens form. Furthermore, the major axes of the light intensity distribution patterns LDPa and LDPb are arranged so as to intersect. To improve the detection resolution of the position detection light signal LSp, it is very preferable that the angle of intersection of the major axes is set to 90 degrees.

The first light-emitting element LEDa and the second light-emitting element LEDb are arranged on the first surface 1fa and the second surface 1fb, which are adjacent on the four-sided pyramid (four-sided prismoid), but there is no limitation to this, and it is possible for these to be arranged on a multi-sided pyramid (multi-sided prismoid) such as a three-sided pyramid (three-sided prismoid) or on appropriate positions of a hemispherical surface. It should be noted that it is very preferable for the first surface 1fa and the second surface 1fb to be adjacent in order to improve detection accuracy. Furthermore, it is not necessary that the first surface 1fa and the second surface 1fb be side surfaces of a multi-sided pyramid (multi-sided prismoid) having a perfect shape as long as they are intersect adjacently and are configured as inclined surfaces inclined to the reference axis BAX. That is, they may be configured as a portion of multi-sided pyramid (multi-sided prismoid) having an imperfect shape (see FIG. 8B).

FIG. 6A is a lateral view of the optical indicator device 1, and FIG. 6B shows light intensity distribution patterns from the arrows 6B to 6B (a surface perpendicular to the light axes LAXa and LAXb) shown in FIG. 6A. At the second direction (Y-axis direction) that intersects the reference axis BAX, the light axis LAXb of the second light-emitting element LEDb is configured at an inclination angle θb to the reference axis BAX. By ensuring that the inclination angle θb is not greater than a half value angle of the second light-emitting element LEDb, the position detection light signal LSp from the second light-emitting element LEDb can be detected reliably by the position detection light-receiving element 3p.

The mutual relationship between the light intensity distribution pattern LDPa of the light intensity distribution characteristic LDAa and the light intensity distribution pattern LDPb of the light intensity distribution characteristic LDAb is the same as in FIG. 5B.

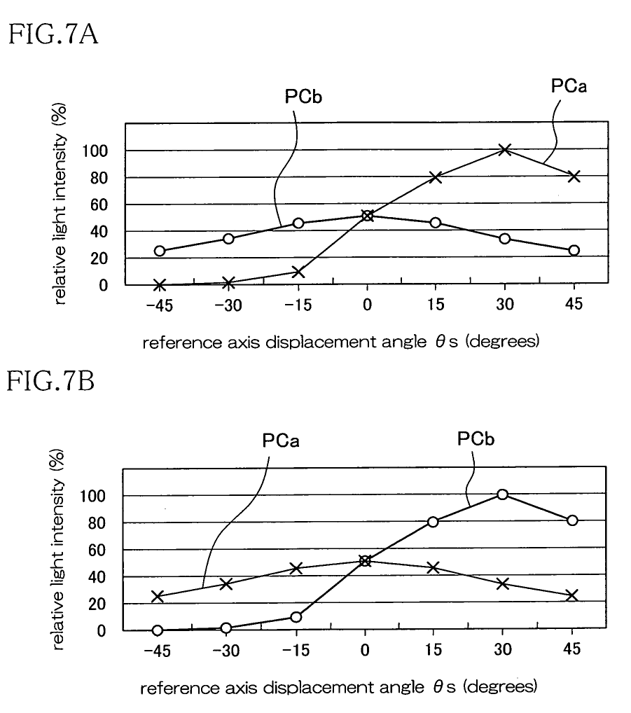

FIGS. 7A and 7B are graphs showing correlation between the relative light intensity of the light-reception signal detected by the position detection light-receiving element receiving the position detection light signal from the optical indicator device shown in FIGS. 4 through 6B, and the reference axis displacement angle as relative light intensity to reference axis displacement angle characteristics. In FIGS. 7A and 7B, the horizontal axis is the reference axis displacement angle θ (degrees) and the vertical axis is relative light intensity (%). Identical symbols are attached to portions identical to FIGS. 1 through 6B and duplicate description thereof is omitted.

FIG. 7A shows change in relative light intensity when the reference axis displacement angle θs of the optical indicator device is moved in the first direction (horizontal direction), and FIG. 7B shows change in relative light intensity when the reference axis displacement angle θs is moved in the second direction (vertical direction).

When the optical indicator device 1 moves, the reference axis BAX (reference axis displacement angle θs) also changes in accordance to this. Furthermore, in accordance to change in the reference axis BAX, the relative light intensity PCa obtained from the light-reception signal of the position detection light-receiving element 3pa (see FIG. 10), which receives as input a position detection light signal LSpa from the first light-emitting element LEDa and the relative light intensity PCb obtained from the light-reception signal of the position detection light-receiving element 3pb (see FIG. 10), which receives as input a position detection light signal LSpb from the second light-emitting element LEDb change together in accordance to the reference axis displacement angle θs.

When the optical indicator device 1 is moved (FIG. 7A) in the first direction (horizontal direction: X-axis direction), the position detection light-receiving element 3pa detects change in the minor axis direction of the light intensity distribution pattern LDPa, which is the light signal from the first light-emitting element LEDa, and therefore the relative light intensity PCa is shown as the maximum value (100% for example) when the reference axis displacement angle θs moves from 0 to the plus direction and becomes a half value angle (for example, 30 degrees), moreover, the width of the change becomes larger. When the reference axis displacement angle θs moves from 0 to the minus direction, the relative light intensity PCa gradually decreases (attenuates).

On the other hand, the position detection light-receiving element 3pb detects change in the major axis direction of the light intensity distribution pattern LDPb, which is the light signal from the second light-emitting element LEDb, and therefore the relative light intensity PCb is shown as the maximum value (50% for example) when the reference axis displacement angle θs becomes 0 and, moreover, the width of the change becomes smaller. Even if the reference axis displacement angle θs moves to either the plus or minus direction, the relative light intensity PCb gradually decreases (attenuates).

When the optical indicator device 1 is moved (FIG. 7B) in the second direction (vertical direction: Y-axis direction), the position detection light-receiving element 3pb detects change in the minor axis direction of the light intensity distribution pattern LDPb, which is the light signal from the second light-emitting element LEDb, and therefore the relative light intensity PCb is shown as the maximum value (100% for example) when the reference axis displacement angle θs moves from 0 to the plus direction and becomes a half value angle (for example, 30 degrees), moreover, the width of the change becomes larger. When the reference axis displacement angle θs moves from 0 to the minus direction, the relative light intensity PCb gradually decreases (attenuates).

On the other hand, the position detection light-receiving element 3pa detects change in the major axis direction of the light intensity distribution pattern LDPa, which is the light signal from the first light-emitting element LEDa, and therefore the relative light intensity PCa is shown as the maximum value (50% for example) when the reference axis displacement angle θs becomes 0 and, moreover, the width of the change becomes smaller. Even if the reference axis displacement angle θs moves to either the plus or minus direction, the relative light intensity PCa gradually decreases (attenuates).

It should be noted that the first light-emitting element LEDa and the second light-emitting element LEDb having different light emission wavelengths (light emission wavelength regions) is as described in FIGS. 2 and 3. That is, if the first light-emitting element LEDa has a light emission wavelength in the infrared light region, then the second light-emitting element LEDb is configured to have a light emission wavelength in the visible light region.

Accordingly, the relative light intensity PCa can be detected by the position detection light-receiving element 3pa and the relative light intensity PCb can be detected by the position detection light-receiving element 3pb. It should be noted that correction by distance or the like becomes necessary when light intensity is given as an absolute value, and therefore the relative light intensities PCa and PCb are obtained to facilitate subsequent arithmetic processing, etc., but if the distance is constant and an absolute value can be specified easily, it is also possible to obtain the light intensity as an absolute value.

Two types of light intensities from the position detection light-receiving elements 3pa and 3pb corresponding to the reference axis displacement angle θs (namely, the relative light intensity PCa and the relative light intensity PCb, or two types of light intensities obtained as absolute values) can be obtained, and therefore the movement of the optical indicator device 1, that is, the position signals given as indication from the optical indicator device 1 relating to the position of the pointer 4, can be obtained by the light-receiving device 3 using appropriate arithmetic processing on the two types of obtained light intensities.

It should be noted that, the light intensity is in fact detected as an electric signal of the light-reception signal, and therefore the magnitude of the light intensity can be detected as an output level (amplitude value) of the light-reception signal. Accordingly, performing arithmetic processing on light intensities refers to performing arithmetic processing by comparing the magnitudes of the output levels of the detected light-reception signals. Arithmetic processing can be carried out easily on the output levels of the light-reception signals by performing analog/digital conversion as appropriate to obtain digital values. Arithmetic processing can be carried out using an ordinarily used microcomputer (a central processing unit (CPU)).

As techniques for performing arithmetic processing on the output level of the light-reception signals, there is a technique of performing arithmetic processing based on the difference between two types of output levels, a technique of performing arithmetic processing based on the ratio of two types of output levels, and a technique of performing arithmetic processing based on the difference between and the ratio of two types of output levels, and any of these techniques may be used. In particular, it is possible to further improve precision when performing arithmetic processing based on both the difference between and the ratio of output levels.

FIGS. 8A and 8B are front views of modified examples of optical indicator devices in remote control devices according to the present invention shown in FIG. 4. FIG. 8A shows a first modified example and FIG. 8B shows a second modified example. Identical symbols are attached to portions identical to FIG. 4 and description thereof is omitted as appropriate.

In FIG. 4, in the optical indicator device 1, a four-sided pyramid is configured on the side facing the light-receiving device 3, but in the first modified example, a four-sided prismoid having an apex surface its is formed by making the apex it portion be a flat surface in a direction intersecting the reference axis BAX. A third light-emitting element LEDc that emits as output the function control light signal LSc is provided at the apex surface its. That is, the third light-emitting element LEDc (apex surface its) is provided facing the same direction as the reference axis BAX, and therefore it is possible to carry out transmission of the function control light signal LSc easily and reliably.

The second modified example is formed as a triangle without inclinations of the third surface 1fc and the fourth surface 1fd and with the apex surface its occupying a half of the front surface (front surface view), and the remaining half set to the first surface 1fa and the second surface 1fb. That is, the modified example is configured such that only the first surface 1fa and the second surface 1fb are multi-sided pyramids with inclined areas.

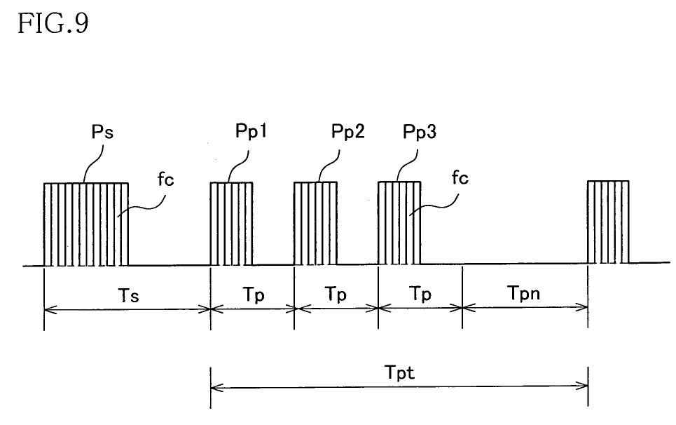

FIG. 9 is a waveform chart showing an example waveform of light emission pulse signals at the optical indicator device of a remote control device according to the present invention.

The drive portion (unshown) of the optical indicator device 1 respectively applies light emission pulse signals to the first light-emitting element LEDa and the second light-emitting element LEDb. In response to the light emission pulse signals, the first light-emitting element LEDa and the second light-emitting element LEDb emit as output position detection light signals LSp of different light emission wavelengths for transmission to the light-receiving device 3 (position detection light-receiving element 3p).

The light emission pulse signals are constituted by position detection pulses Pp1, Pp2, and Pp3, and a detection start pulse Ps that is produced before the position detection pulse Pp1. By repetitively producing a plurality of position detection pulses Pp1, Pp2, and Pp3 having the same pulse width and cycle, a consistent position detection light signal LSp can be emitted as output, and therefore it is possible to achieve exact position detection.

Furthermore, ordinarily used modulation carrier wave fc of approximately 10 kHz to 40 kHz are superimposed on the position detection pulses Pp1, Pp2, and Pp3, and the detection start pulse Ps. By superimposing the modulation carrier wave fc, detection errors due to disturbance light (noise) can be prevented.

The position detection pulses Pp1, Pp2, and Pp3 have position detection pulse single cycles Tp, which are of respectively equivalent cycles. Furthermore, the position detection pulses Pp1, Pp2, and Pp3 have a position detection pulse group cycle (sensing cycle) Tpt that includes these three pulses in entirety. The position detection pulse single cycles Tp are approximately 1 ms (millisecond) for example, and the periods in which the position detection pulses Pp1, Pp2, and Pp3 are produced (ON condition period during the position detection pulse single cycles Tp) are set to half (approximately 0.5 ms) of the position detection pulse single cycles Tp. A signal-less period Tpn is provided corresponding to two pulses after the three pulses (Pp1, Pp2, and Pp3) are produced, and therefore the position detection pulse group cycle (sensing cycle) Tpt is approximately 5 ms.

The detection start pulse Ps of the detection start pulse cycle Ts is produced before the position detection pulse group cycle (sensing cycle) Tpt. The detection start pulse cycle Ts is set to approximately 2 ms for example. The period in which the detection start pulse Ps is produced (ON period during the detection start pulse cycle Ts) is set to half of the detection start pulse cycle Ts (approximately 1 ms). A detection operation of the position detection light signal LSp at the light-receiving device 3 can be started by the detection start pulse Ps, thus controllability of the detection function can be increased.

Pulses of the above-mentioned cycles are also used in ordinary remote controllers (remote control devices that produce a function control signal) and therefore no special item is required in terms of circuitry or components, such that construction can be achieved easily. Furthermore, position signals are sent and received optically using electric circuitry, and therefore the pointer 4 can be moved smoothly and speedily compared to position control based on mechanical remote control.

FIG. 10 is a block diagram showing a working example of a circuit block of the light-receiving device in a remote control device according to the present invention.

The light-receiving device 3 detects the light intensity (amplitude value) of the position detection light signal LSp, which is received as input, using a first light-receiving circuit 30a and a second light-receiving circuit 30b, and a position signal is obtained by performing arithmetic processing on the detected light intensities by an arithmetic processing portion 5, with this position signal being outputted to perform movement control of the position of the pointer 4 displayed on the display portion 2a.

It should be noted that the light emission wavelengths of the first light-emitting element LEDa and the second light-emitting element LEDb are different, and therefore appropriate separation is achieved by setting the light emission output from the first light-emitting element LEDa to a position detection light signal Lspa, and setting the light emission output from the second light-emitting element LEDb to a position detection light signal LSpb.

The first light-receiving circuit 30a is constituted by an optical filter 3fa having a wavelength selection characteristic by which the position detection light signal LSpa that is emitted as output from the first light-emitting element LEDa is selected, a position detection light-receiving element 3pa that receives the position detection light signal LSpa that has passed through the optical filter 3fa and detects a light-reception signal (a light-reception pulse signal corresponding to the light emission pulse signal; hereinafter simply referred to as “light-reception signal” when it is not necessary to specify “light-reception ‘pulse’ signal”), an amplifier circuit 31a for amplifying the light-reception signal detected by the position detection light-receiving element 3pa, a band-pass filter 32a that reduces noise by allowing only a predetermined frequency to pass from the light-reception signal amplified by the amplifier circuit 31a, an amplitude value detection circuit 33a for detecting an amplitude value (light intensity, relative light intensity, output level) of the light-reception signal that has been outputted from the band-pass filter 32a, and an automatic gain control circuit (AGC) 34a that regulates the amplification factor of the amplifier circuit 31a.

The second light-receiving circuit 30b is constituted by an optical filter 3fb having a wavelength selection characteristic by which the position detection light signal LSpb that is emitted as output from the second light-emitting element LEDb is selected, a position detection light-receiving element 3pb that receives the position detection light signal LSpb that has passed through the optical filter 3fb and detects a light-reception signal (a light-reception pulse signal), an amplifier circuit 31b for amplifying the light-reception signal detected by the position detection light-receiving element 3pb, a band-pass filter 32b that reduces noise by allowing only a predetermined frequency to pass from the light-reception signal amplified by the amplifier circuit 31b, an amplitude value detection circuit 33b for detecting an amplitude value (light intensity, relative light intensity, output level) of the light-reception signal that has been outputted from the band-pass filter 32b, and an automatic gain control circuit (AGC) 34b that regulates the amplification factor of the amplifier circuit 31b.

The position detection light-receiving element 3pa and the position detection light-receiving element 3pb can be configured as photodiodes or phototransistors for example. Since the optical filter 3fa and the optical filter 3fb are used, elements of the same specification can be used. It should be noted that it is also possible to provide a wavelength selection characteristic to the position detection light-receiving element 3pa and the position detection light-receiving element 3pb themselves without using the optical filter 3fa and the optical filter 3fb.

Since the optical filter 3fa and the optical filter 3fb have wavelength selection characteristics, a position detection light signal LSp of the infrared light region and a position detection light signal LSp of the visible light region can be reliably separated and detected as separate data (light-reception signals and light-reception pulse signals). For example, a configuration is possible in which if the wavelength region of emitted light of the first light-emitting element LEDa is the infrared light region, then the optical filter 3fa is set to have a wavelength selection characteristic that allows wavelengths in the infrared light region to pass, thereby detecting the position detection light signal LSpa of the infrared light region, and if the wavelength region of emitted light of the second light-emitting element LEDb is the visible light region, then the optical filter 3fb is set to have a wavelength selection characteristic that allows wavelengths in the visible light region to pass, thereby detecting the position detection light signal LSpb of the visible light region.

The automatic gain control circuits 34a and 34b detect the maximum values of the amplitude values of light-reception signals outputted from the band-pass filters 32a and 32b, and regulate the amplification factors so that (the maximum values of) the amplitude values of the light-reception signals do not saturate in the amplifier circuits 31a and 31b. Since (the maximum values of) the amplitude values do not saturate, it is possible to obtain light-reception signals (light-reception signal levels) that have high detection accuracy, and high stability and reliability.

In particular, regulation of the amplification factor can be performed speedily by detecting (the maximum value of) the amplitude values of the light-reception pulse signals detected in response to the detection start pulse Ps of the detection start pulse cycle Ts to carry out regulation of the amplification factor. Furthermore, regulation can be achieved by producing a separate amplification factor regulation pulse signal (not shown), emitting as output a corresponding light emission pulse signal, and detecting the amplitude values of the corresponding light-reception pulse signals.

The position signals are obtained by the arithmetic processing portion appropriately performing arithmetic processing on the amplitude values (light intensities) of the light-reception signals detected respectively by the amplitude value detection circuits 33a and 33b, and the position of the pointer 4 can be controlled by outputting these as position signals (position control signals) from the arithmetic processing portion 5 to the display portion 2a. The arithmetic processing portion 5 can be configured using a CPU or the like that is ordinarily used.

The arithmetic processing in the arithmetic processing portion 5 can be arithmetic in which a difference between the amplitude value of the light-reception signal obtained by the first light-receiving circuit 30a and the amplitude value of the light-reception signal obtained by the second light-receiving circuit 30b is obtained, arithmetic in which a ratio of these amplitude values is obtained, or arithmetic of a combination of obtaining the difference between and the ratio of these amplitude values.

The light-receiving device 3 is further provided with a third light-receiving circuit (not shown) for receiving as input the function control light signal that is emitted as output from the third light-emitting element LEDc corresponding to the function control signal that controls the functions of the display device 2 (display portion 2a). The third light-receiving circuit outputs the function control light signal, which is received as input, as a function control signal using commonly known signal transformation, and the functions of the display device 2 (display portion 2a) are controlled using the arithmetic processing portion 5 or the like. The third light-receiving circuit can receive the function control light signal using the function control light-receiving element 3c (see FIG. 1).

As with the first light-emitting element LEDa and the second light-emitting element LEDb, it is very preferable that the third light-emitting element LEDc is configured by a light-emitting element having a predetermined wavelength of light emission (for example, a semiconductor light-emitting diode: LED), since this improves detection accuracy. For example, by setting this to light emission wavelength of the infrared light region or a light emission wavelength of the visible light region, it is possible to differentiate from disturbance light, thus making it possible to improve detection accuracy.

By configuring the function control light-receiving element 3c as a component having wavelength selection characteristics by which the same wavelength as the third light-emitting element LEDc can be selected, it becomes possible to accurately detect the function control light signal LSc.

By employing a time sharing system, it is possible to achieve combined use of the third light-emitting element LEDc in the first light-emitting element LEDa or in the second light-emitting element LEDb. That is, by omitting the third light-emitting element LEDc, the optical indicator device 1 can be simplified. Furthermore, when the function control light signal LSc is emitted as output, the modulation carrier wave fc that is superimposed on the light emission pulse signal can be made different from the position detection light signal LSp.

By employing a time sharing system in the transmitting and receiving of the position detection light signals LSp, a third light-receiving circuit can be combined in use in either the first light-receiving circuit 30a or the second light-receiving circuit 30b. In this case, the light-receiving device 3 can be simplified by not requiring a separate third light-receiving circuit to be configured.

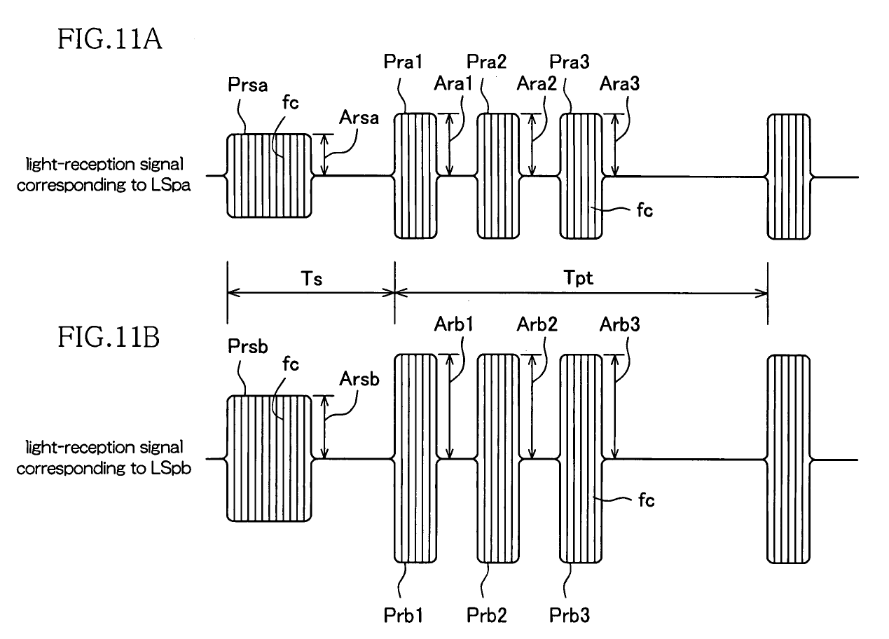

FIGS. 11A and 11B are waveform diagrams showing examples of amplitude values of light-reception signals that have been output from band-pass filters. Description related to portions identical to FIG. 9 is omitted as appropriate.

In FIG. 11A, a light-reception pulse signal corresponding to the position detection light signal LSpa that is emitted as output from the first light-emitting element LEDa (that is, a light-reception signal as output of the band-pass filter 32a) is shown. In FIG. 11B, a light-reception pulse signal corresponding to the position detection light signal LSpb that is emitted as output from the second light-emitting element LEDb (that is, a light-reception signal as output of the band-pass filter 32b) is shown.

The pulse cycle is the same as the light emission pulse signals shown in FIG. 9. That is, in the first light-receiving circuit 30a, a detection start light-reception pulse Prsa corresponding to the detection start pulse Ps, and position detection light-reception pulses Pra1, Pra2, and Pra3 corresponding to the position detection pulses Pp1, Pp2, and Pp3 are obtained as light-reception pulse signals, and in the second light-receiving circuit 30b, a detection start light-reception pulse Prsb corresponding to the detection start pulse Ps, and position detection light-reception pulses Prb1, Prb2, and Prb3 corresponding to the position detection pulses Pp1, Pp2, and Pp3 are obtained as light-reception pulse signals.

An amplitude value Arsa of the detection start light-reception pulse Prsa is detected by the automatic gain control circuit 34a so that the amplification factor of the amplifier circuit 31a can be regulated and controlled in the last half of the cycle Ts. Furthermore, an amplitude value Arsb of the detection start light-reception pulse Prsb is detected by the automatic gain control circuit 34b and the amplification factor of the amplifier circuit 31b can be regulated and controlled in the last half of the cycle Ts.

After the amplification factor has been regulated and controlled, amplitude values Ara1, Ara2, and Ara3 of the position detection light-reception pulses Pra1, Pra2, and Pra3 in the position detection pulse group cycle Tpt are obtained using the amplitude value detection circuit 33a, and outputted to the arithmetic processing portion 5. By setting the average of the amplitude values Ara1, Ara2, and Ara3 as the amplitude value of the light-reception pulse signals, it becomes possible to improve detection accuracy. Three pulses were used when obtaining the average, but a plurality of pulses may be used, and there is no limitation to three. It should be noted that the average may be obtained at either the amplitude value detection circuit 33a or the arithmetic processing portion 5.

The same processes as the amplitude value detection circuit 33a are also carried out in the amplitude value detection circuit 33b. The position signals are obtained and output by comparing (arithmetic processing) at the arithmetic processing portion 5 (the average of) the amplitude values of the light-reception pulse signals corresponding to the position detection light signal LSpa and (the average of) the amplitude values of the light-reception pulse signals corresponding to the position detection light signal LSpb.

The present invention can be embodied and practiced in other different forms without departing from the purport and essential characteristics thereof. Therefore, the above-described working examples are considered in all respects as illustrative and not restrictive. The scope of the invention is indicated by the appended claims rather than by the foregoing description. All variations and modifications falling within the equivalency range of the appended claims are intended to be embraced therein.

1. A remote control device comprising an optical indicator device in which a first light-emitting element and a second light-emitting element are mounted that emit as output a position detection light signal, and a light-receiving device that receives as input the position detection light signal and obtains a position signal from a detected light-reception signal,
wherein a light axis of the first light-emitting element has an inclination angle not greater than a half value angle of the first light-emitting element to a reference axis in a first direction that intersects the reference axis of the optical indicator device, and
a light axis of the second light-emitting element has an inclination angle not greater than a half value angle of the second light-emitting element to the reference axis in a second direction that intersects the first direction.

2. A remote control device according to claim 1, wherein the first light-emitting element is mounted at a first surface formed in the first direction, and the second light-emitting element is mounted at a second surface formed in the second direction.

3. A remote control device according to claim 2, wherein the first surface and the second surface are configured as two adjacent side surfaces of a multi-sided pyramid or a multi-sided prismoid.

4. A remote control device according to claim 1, wherein an angle of intersection of the first direction and the second direction is 90 degrees.

5. A remote control device according to claim 1, wherein the first light-emitting element and the second light-emitting element have different light emission wavelengths.

6. A remote control device according to claim 5, wherein the first light-emitting element has a light emission wavelength in an infrared light region or a visible light region, and the second light-emitting element has a light emission wavelength in a visible light region or an infrared light region.

7. A remote control device according to claim 1, wherein light intensity distribution patterns at surfaces vertical to the light axes of the first light-emitting element and the second light-emitting element are oval shaped.

8. A remote control device according to claim 7, wherein major axis directions of the oval shapes of the light intensity distribution patterns of the first light-emitting element and the second light-emitting element are intersecting.

9. A remote control device according to claim 8, wherein an angle of intersection of the major axis directions is 90 degrees.

10. A remote control device according to claim 1, wherein position detection light signals are emitted as output by applying light emission pulse signals in which a modulation carrier wave is superimposed on position detection pulses respectively to the first light-emitting element and the second light-emitting element.

11. A remote control device according to claim 10, wherein the light emission pulse signal has a detection start pulse, on which the modulation carrier wave is superimposed, before the position detection pulses.

12. A remote control device according to claim 10, wherein the position detection pulses are constituted by a plurality of pulses having a same pulse width and a same cycle.

13. A remote control device according to claim 5, wherein the light-receiving device comprises two position detection light-receiving elements having different wavelength selection characteristics corresponding to the light emission wavelengths.

14. A remote control device according to claim 13, wherein the position detection light-receiving elements comprise optical filters having different wavelength selection characteristics.

15. A remote control device according to claim 13, wherein the position signal is obtained by performing arithmetic processing on a difference between output levels of light-reception signals detected by the two position detection light-receiving elements.

16. A remote control device according to claim 13, wherein the position signal is obtained by performing arithmetic processing on a ratio of output levels of light-reception signals detected by the two position detection light-receiving elements.

17. A remote control device according to claim 13, wherein the position signal is obtained by performing arithmetic processing on a difference between and a ratio of output levels of light-reception signals detected by the two position detection light-receiving elements.

18. A remote control device according to claim 13, wherein the light-receiving device comprises a first light-receiving circuit and a second light-receiving circuit corresponding respectively to the two position detection light-receiving elements and an arithmetic processing portion that obtains a position signal by performing arithmetic processing on the light-reception signals detected by the first light-receiving circuit and the second light-receiving circuit.

19. A remote control device according to claim 18, wherein the first light-receiving circuit and the second light-receiving circuit respectively comprise the position detection light-receiving element that receives as input the position detection light signal to detect a light-reception signal, an amplifier circuit that amplifies the light-reception signal detected by the position detection light-receiving element, and an amplitude value detection circuit that detects an amplitude value of the light-reception signal amplified by the amplifier circuit.

20. A remote control device according to claim 19, wherein amplitude values obtained for a plurality of pulses of the light-reception signals corresponding to the position detection pulses are averaged and the average is set as an amplitude value of the light-reception signals.

21. A remote control device according to claim 19, wherein a band-pass filter is connected between the amplifier circuit and the amplitude value detection circuit.

22. A remote control device according to claim 19, wherein amplification factor of the amplifier circuit is regulated by an automatic gain control circuit.

23. A remote control device according to claim 22, wherein the amplification factor is regulated such that the amplitude value of the light-reception signal corresponding to the detection start pulse does not saturate.

24. A display device provided with a display portion that displays information and a frame portion that supports the display portion, comprising a remote control device according to claim 1, wherein the light-receiving device is arranged at a front surface of the frame portion.

25. A display device according to claim 24, wherein the optical indicator device emits as output and transmits to the light-receiving device a function control light signal corresponding to a function control signal that controls a function of the display device, and the light-receiving device receives as input the function control light signal and outputs the function control signal.

26. A display device according to claim 25, wherein the optical indicator device comprises a third light-emitting element that emits as output the function control light signal.

27. A display device according to claim 26, wherein the third light-emitting element has a light emission wavelength in an infrared light region or a visible light region.

28. A display device according to claim 25, wherein the function control light signal is emitted as output from either one of the first light-emitting element and the second light-emitting element.

29. A display device according to any claim 25, wherein the light-receiving device comprises a function control light-receiving element that receives as input the function control light signal.

30. A display device according to claim 29, wherein the function control light-receiving element has a wavelength selection characteristic corresponding to the light emission wavelength.

31. A display device according to claim 25, wherein the function control light signal is received as input by either one of the two position detection light-receiving elements.

32. A display device according to claim 24, wherein a position of a mark displayed on the display portion is controlled according to the position signal.

33. A display device according to claim 24, wherein the display device is a television receiver.
